(19) United States
(12) Patent Application Publication
(10) Pub. No.: US 2021/0195304 A1
(43) Pub. Date: Jun. 24, 2021

(54) DISPLAY MOUNT INTERFACES

(71) Applicant: Hewlett-Packard Development Company, L.P., Spring, TX (US)

(72) Inventors: Daniel Young Yoon, Palo Alto, CA (US); Glenn A. Wong, Palo Alto, CA (US); Kevin Luke Massaro, Spring, TX (US); Arthur Harvey Zarnowitz, Palo Alto, CA (US)

(73) Assignee: HEWLETT-PACKARD DEVELOPMENT COMPANY, L.P., Spring, TX (US)

(21) Appl. No.: 16/722,677

(22) Filed: Dec. 20, 2019

(51) Int. Cl. H04R 1/02; H04R 1/28

(52) U.S. Cl. CPC H04R 1/025; H04R 2499/15; H04R 1/028; H04R 1/2811

(57) ABSTRACT

In an example, a speaker support apparatus includes a display mount interface to couple to a bezel edge of a display and a shelf coupled to the display mount interface via a beam that is nonparallel with respect to the bezel edge of the display.

### BACKGROUND

Entertainment systems may include a display system and an audio system. The components of the entertainment system may be electronic devices capable of processing visual or auditory signals to produce images and/or sounds for a user of the entertainment system. Entertainment systems may include a plurality of components to generate the experience desired by the user.

### BRIEF DESCRIPTION OF THE DRAWINGS

FIG. 1 is a block diagram depicting an example speaker support apparatus.

FIG. 2 is a block diagram depicting an example audio system.

FIG. 3 is a block diagram depicting an example display system.

FIG. 4 is a perspective view of an example display system with an example audio system attached.

FIG. 5 is a perspective view of the bottom corner of an example display system with an example audio system attached.

FIG. 6 is an exploded view of components of FIG. 5.

FIG. 7 is a front view of the example display system with example internal structure shown.

FIG. 8 is an exploded view of an example audio system including an example speaker support apparatus.

### DETAILED DESCRIPTION

In the following description and figures, some example implementations of speaker support apparatus, audio systems, and/or display systems are described.

In examples described herein, an “audio device” may be a device to generate sound waves. Examples audio devices may include any speaker (e.g., loudspeaker), such as an electroacoustic transducer. Example transducers may include a woofer, a subwoofer, a mid-range driver, a tweeter, and the like. An audio system includes the transducer and support structure to sustain the transducer in a desired direction. A speaker audio system may come in any number of standalone form factors and cabinet designs, such as soundbars, floor-standing loudspeakers, or bass cabinets. A speaker audio system may also be integrated into other systems, such as laptops, televisions, computer monitors, automobiles, etc.

In examples described herein, a “display device” may be a device to present content visually. Example displays may include a screen such as a liquid crystal display (LCD) panel, an organic light-emitting diode (OLED) panel, a micro light emitting diode (PLED), or other display technology. In some examples, a display device may also include circuitry to operate the screen, such as a monitor scaler. A display device may present (e.g., displays) an image on a panel using color to determine a color to display for every pixel on the panel. The source image data may include color data according to a color space such as red, green, and blue (RGB) channel data. Source image data may also be associated with source audio date corresponding to sound to be made relative the presentation of the image data. Support structures, such as a wall-mount, stand, or legs, may be coupled to the display device to form a display system.

A user may desire for a display system and audio system to appear integrated when the systems includes individual devices. For example, a user may attach an audio system to a display system such that if the display system is rotated, the audio system rotates as well. Some audio systems utilize separate attachments to connect to a wall mount system that couples the display to a wall. This generally entails connecting a support structure to the wall mount interface located on the back of the display.

Various examples described below relate to a speaker support apparatus that is directly coupleable to a bezel edge of a display device rather than the back of the display device. By locating the display mount interface for the speaker on the bezel edge, a user may have quicker access to removal of the stand when the display system switches between wall-mounted mode and table-top mode, for example. The display device of the display system may be built to support attachment of the display mount interface and a speaker (e.g., may include an internal support structure capable of supporting external attachments and loads of the attachments).

An example entertainment system consistent with the following descriptions may include aspects of various audio and/or display systems, such as an entertainment system with a display system including a screen and bezel, an audio system including a speaker, and a speaker support apparatus to support the speaker at a location with respect to the screen. For example, the speaker support apparatus may be a unibody bracket or a plurality of parts that couple to the bottom of the display system at the bezel edge to form a shelf on which the speaker may be supported, such as directly supporting the speaker housing to be as close to the bezel edge as possible. In some examples shown herein, two speaker support apparatus may be used to support each end of a speaker directly from the display system via the bezel. In this manner, the speaker support apparatus may locate the speaker and compliment the display system such that a viewer of the display system may perceive the audio system to be a part of the display system or otherwise have the appearance of a single entertainment device, for example.

FIG. 1 is a block diagram depicting an example speaker support apparatus 100. The example speaker support apparatus 100 generally includes a display mount interface 102, a beam 104, and a shelf 106. The components of the speaker support apparatus 100 may be made of metal, plastic, or some other blend of materials capable of supporting a physical object, such as an audio device. The speaker support apparatus 100 may be separate from (and mountable to) a display device and is not encompassed within the housing of a display device or otherwise integrated in the display device. Indeed, the speaker support apparatus 100 may be said to be an add-on accessory to customize the entertainment experience of a display device to include an audio system that extends from the display bezel edge via the speaker support apparatus 100, for example.

The display mount interface 102 is a physical structure defining a detent to couple the speaker support apparatus to a bezel edge of a display device. For example, the display mount interface 102 may be a beam or plate that is capable of being connected to a display device, such as a flat plate with threaded through-holes useable with screws. As used herein, a detent is any surface or structural contour that creates an area mateable with a counterpart surface. An example detent may be a recess, a protrusion, a tab, a hole, a texture, a pattern, or the like. The display mount interface 102 may include a plurality of detents, such as a plurality of screw holes or fastening protrusions that complement an interface on the bezel edge of the display device. The detent may allow the display mount interface 102 to be attached substantially flush with respect to the bezel edge of the display device and, therefore allow for the speaker support apparatus 100 to substantially flush with the display device (e.g., substantially flush with respect to the bezel edge of the display device). The display mount interface 102 may include an alignment feature corresponding to a feature on the display bezel edge to coordinate orientation of the speaker support apparatus to the display device. The alignment feature may be the same as the detent of the display mount interface 102 used to couple to the display device or may be an additional detent. As discussed further herein, a support beam, such as beam 404, may extend from the display mount interface 102, which may allow for further extension of a shelf, such as shelf 106, to support an object from the display mount interface 102.

The shelf 106 is a physical structure defining a platform or housing on which an item may rest or be secured. For example, a shelf 106 may be a cantilever support extending substantially perpendicular from the speaker support structure. In another example, the shelf 106 may be a ledge that is supported by additional beams to support a desired weight limit. The shelf 106 is coupled to the display mount interface 102 by the beam 104. Weight placed on the shelf 106 may be transferred to the display mount interface 102 (and, therefore, to the display device that the display mount interface 102 is connected to) via the beam 104. For example, the shelf 106 may support the weight of a speaker via the beam and physical connection at the display mount interface 102 to the display. The shelf 106 may include a detent complementary to the shape of the supported object to assist the object to align and/or secure the object to the shelf 106. For example, the shelf 106 may include a protrusion complementary to a recess of the surface of a speaker to center the speaker on the shelf 106.

The beam 104 is a physical structure extending a length between the display mount interface 102 and the shelf 106. For example, the beam 104 may be a length equal to or greater than the height of a speaker that is to rest on the shelf 104. The beam may be non-parallel with respect to the display mount interface (e.g., parallel with respect to a bezel edge of the display to which the display mount interface may be mounted). For example, the beam 104 may be substantially perpendicular to the display mount interface 102 and substantially perpendicular to the shelf 106. In another example, the beam 104 may be oblique with respect to the extension of the shelf 106 from the beam and/or oblique with respect to the display mount interface 102 (e.g., may extend at an oblique angle with respect to the bezel edge of a display).

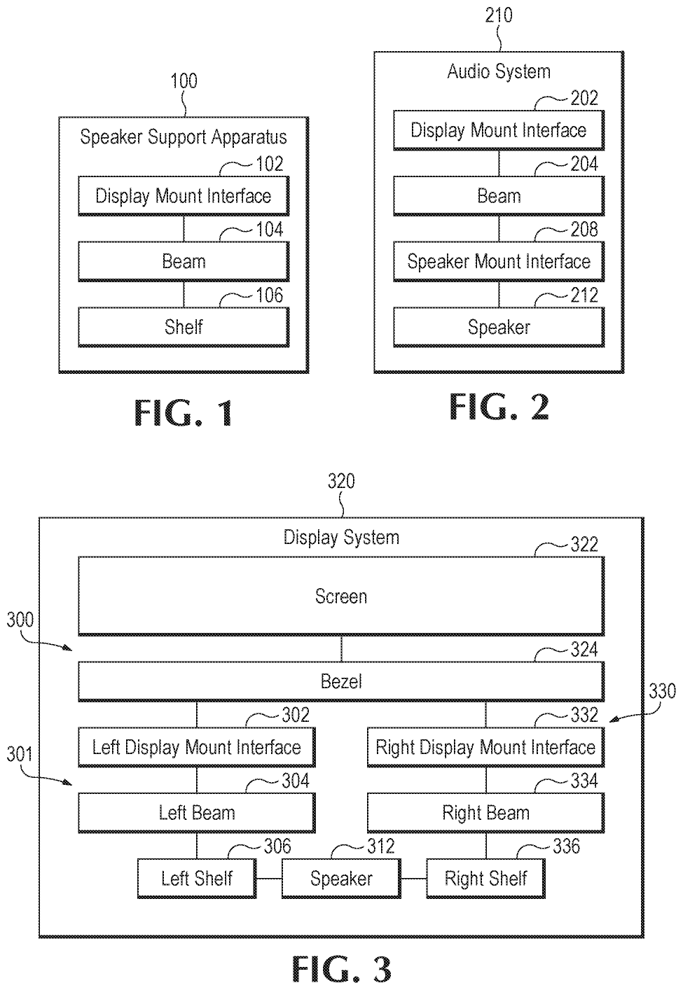

FIG. 2 is a block diagram depicting an example audio system 210. The example audio system 210 generally includes a display mount interface 202, a beam 204, a speaker mount interface 208, and a speaker 212. The display mount interface 202 and the beam 204 may be the same as the display mount interface 102 and the beam 104 of the speaker support apparatus 100 of FIG. 1, and, for brevity, their descriptions are not repeated in their entirety.

The speaker 212 is mounted to the beam 204 via the speaker mount interface 208. The speaker mount interface 208 is a physical structure defining a detent to couple a speaker to the speaker support apparatus. For example, the speaker mount interface 208 may be a beam or plate that is capable of being connected to by mount interface on a speaker, such as a flat plate with threaded through-holes useable with screws. The speaker 212 may be separate and individual component with respect to the speaker support apparatus 200. The speaker 212 may be integrated into an audio or other electronic device where the audio or electronic device is capable of being supported by the beam 204 (or the shelf 106 of FIG. 1).

FIG. 3 is a block diagram depicting an example display system 320. The display system 320 generally includes a screen 322, a bezel 324, and a speaker 312. The speaker support system 301 may include a plurality of speaker support apparatus (e.g., 300 and 330). Referring to FIG. 3, the speaker support system 301 includes a plurality of display mount interfaces (e.g., 302 and 332), a plurality of beams (e.g., 304 and 334), and a plurality of shelves (e.g., 306 and 336). The plurality of display mount interfaces, the plurality of beams, and the plurality of shelves of FIG. 3 may include the display mount interface 102, the beam 104, and the shelf 106 of FIG. 1, and, for brevity, their descriptions are not repeated in their entirety.

The screen 322 may be a display panel having circuitry capable of producing light and color in an arraignment of pixels. The bezel 324 is coupled to the edge of the screen. For example, the bezel 432 may include a plastic housing that covers the periphery of the display panel. As used herein, a bezel is an outside frame around a perimeter of the screen (e.g., such as an outside frame around a computer monitor). The bezel may include the front face section of the frame or housing around the screen and the side edge substantially perpendicular to the front face area of the frame. As used herein, the bezel does not include the back side of the frame around the display or any other portion of the backside of the display system.

The bezel 324 has an edge, such as the front face or the side face. The bezel edge is facing external from the display. For example, the bezel edge may be at the bottom of the display and may be facing downwards when the display is upright for viewing.

The housing or frame of the bezel may include a support mount interface. The support mount interface is a physical structure defining a detent to couple the speaker support apparatus to a bezel edge of a display. For example, the support mount interface may be a set of screw holes that align with or are complementary to screw holes of the display mount interface 302, such that a fastener may couple the display mount interface 302 of the speaker support apparatus to the support mount interface of the display system at the screw holes. The support mount interface may include a support structure internal to the display housing that extends support to display mount interface when the display mount interface is coupled to the support mount interface.

The display mount interface and the support mount interface may be complementary physical structures where the support mount interface is the part of the interface located on the display system and the display mount interface is the part of the interface located on the speaker support apparatus. For example, the display mount interface 302 may lay flush with or be complementary to the support mount interface of the display system. In this manner, the display mount interface may directly couple to the bottom bezel edge of the display. In other examples, the display mount interface may indirectly couple to the display via the bezel.

Referring to FIG. 3, the speaker support system includes a left and right display mount interface, a left and right beam, and a left and right shelf. In this manner, the example display system of 320 of FIG. 3 may include a plurality of speaker support systems to sustain the audio system 310 via the display. In other examples, the audio system 310 may be sustained by a single speaker support system.

The left display mount interface 302 couples to an edge of the bezel 324 on a first portion of a display device and the right display mount interface 332 couples to an edge of the bezel 324 on a second portion of the display device. The left display mount interface 302 may include a structure parallel to and fastenable to the bezel edge such that the display mount interface 302 is supported by the display device via the bezel edge. The right display mount interface 332 may include a similar structure to fasten to the second portion of the display device. In some examples, the display mount interface directly couples to the bottom bezel edge of the display device using a physical coupling, such as a fastener, or through another type of connection, such as interlocking tabs or magnets. The left display mount interface 302 and the right display mount interface 332 may include a face complementary to a shape of the bezel edge, such as a shape that is complementary to the shape of the bottom of the display device. For example, the display mount interface 302 may include an upper face plate to mount flush with the display bezel edge at the bottom of the screen 322.

The speaker support system may include a display mount interface, an upper frame parallel to the bezel 324, a lower frame parallel to the upper frame, a support beam coupling the upper frame and the lower frame, and a shelf coupled to the support beam. The upper frame, lower frame, support beam, and shelf may be made of metal, plastic, or other sturdy material or combination of materials, and may be formed of a unibody piece. The support beam may be perpendicular to the upper frame or oblique with the respect to the upper frame. The shelf may be perpendicular to the support beam or may be oblique with respect to the support beam.

Referring to FIG. 3, the left shelf 306 is coupled to the left display mount interface 302 via the left beam 304 and the right shelf 336 is coupled to the right display mount interface 332 via the right beam 334. The speaker 312 is coupleable to the left shelf 306 and the right shelf 336. For example, the speaker 312 may include a bottom surface to which the left shelf 306 and the right shelf 336 are coupleable, such as by resting one of each end of the speaker on a respective shelf 306 and 336. In some examples, the speaker 312 is fastened to each of the shelves 306 and 336. The speaker 312 may include a face forming a left indent and a right indent, where the left indent is complementary to a shape of the left shelf 306 and the right indent complementary to a shape of the right shelf 336 to assist alignment of the speaker 312 on the shelves. The shelves 306 and 336 may be level with each other in some examples, and, in other examples, the shelves 306 and 336 may be planarly offset. For example, the left shelf 306 extends from the left beam 304 at about a same plane as the right shelf 336 extends from the right beam 334. In some examples, the left shelf 306 and the right shelf 336 are coupled together with a plate to form a support structure across the width between the left and right speaker support apparatus. In some examples, the plate (to which the left shelf 306 and the right shelf 336 are coupled) is integrated in the speaker 412. In other examples, the plate may be separate from the speaker 412 and serve as a full-length support that is at least the same length as the speaker 412 to allow the speaker 412 to be in a rest state between the left and right speaker support apparatus.

The left beam 304 and the right beam 334 may include a front surface that is located flush with the front face of the display (e.g., the front face of the bezel 324 around the screen 322). In other examples, the left beam 304 and the right beam 334 may be offset from the front face of the display to give the appearance that the audio system and the display system are separate. The left beam 304 and the right beam 334 may be nonparallel with respect to the bottom bezel edge of the display.

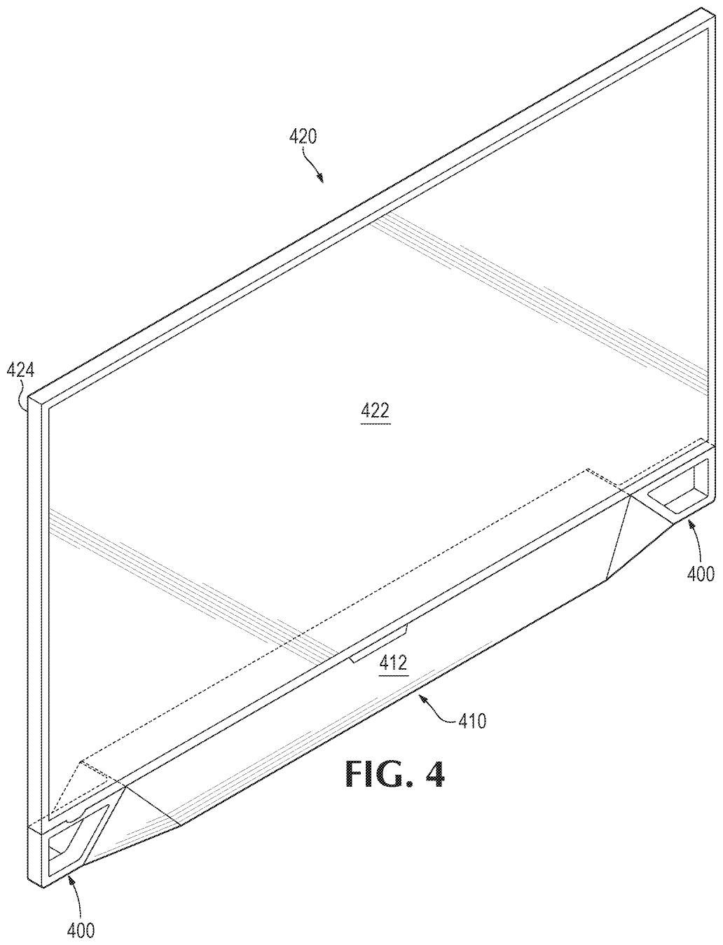

FIG. 4 is a perspective view of an example display system 420 with an example audio system 410 attached. Referring to FIG. 4, the display system 420 may include an audio system 410 attached by speaker support apparatus 400. The speaker 412 of the audio system 410 may be in contact with the bezel 424 surrounding the screen 422 of the display system 420. The speaker support apparatus 400 may be a coupling point between the speaker 412 and the bezel 424, such that the audio system 410 couples to the display 420. As shown in FIG. 4, the speaker support apparatus 400 may be said to extend the footprint of the display to form a space for the speaker 412 under the display and provide a supportive structure to which the speaker 412 may attach and be supported at the bezel 424 (e.g., fastened to the supportive internal structure of the display that is covered by the bezel).

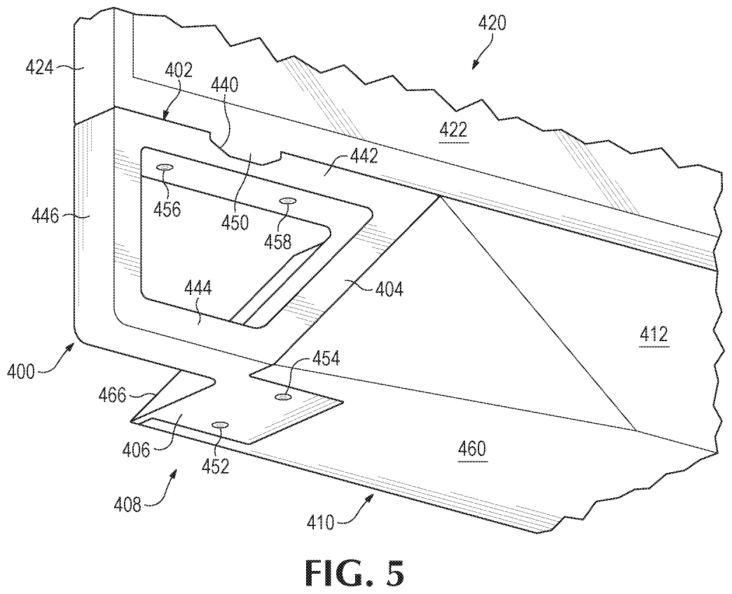

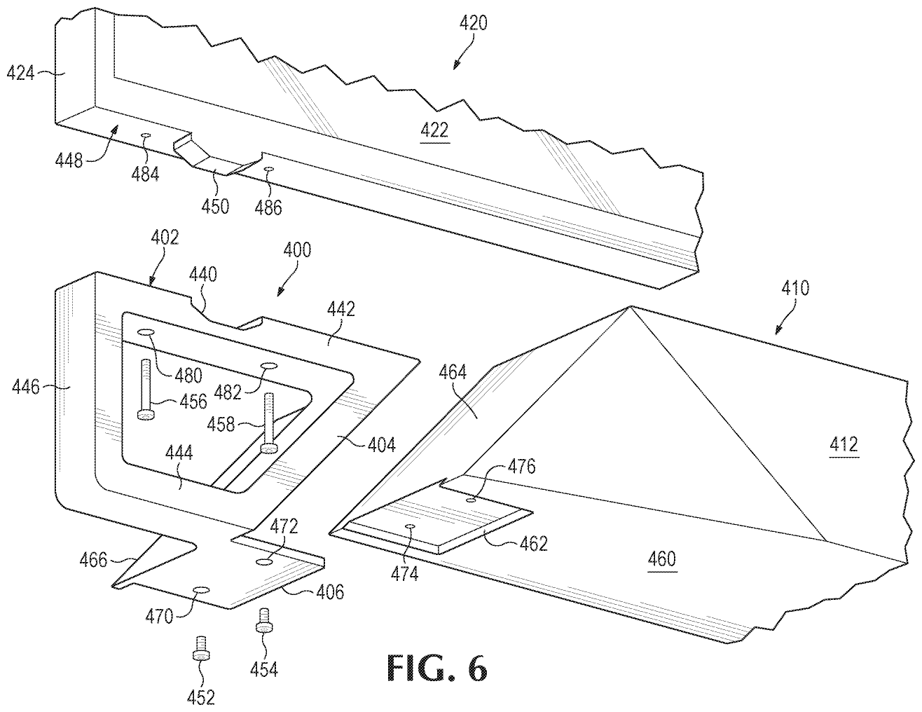

FIG. 5 is a perspective view of the bottom corner of an example display system 420 with an example audio system 410 attached. The speaker 412 is supported by the shelf 406. The shelf 406 may be part of or include a speaker mount interface to which the speaker 412 may be fastened, such as by including holes (e.g., screw holes 470 and 472 as shown in FIG. 6). In the example of FIG. 5, the speaker 412 is secured to the shelf 406 via fasteners 452 and 454 and the speaker support apparatus 400 is secured to the bezel 424 via fasteners 456 and 458. In the example of FIG. 5, the speaker 412 is not directly fastened to the bezel 424, and, instead, the speaker 412 is directly fastened to the shelf 406

The display mount interface 402 may include a surface substantially parallel to the shelf 406. In the example of FIG. 5, the display mount interface 402 includes an upper frame 442 aligned flush with the bezel 424, through which fasteners 456 and 458 extend into the receiving screw holes (not shown in FIG. 5) of the support mount interface (e.g., 448 shown in FIG. 6) of the bezel 424. The beam 404 of FIG. 5 is coupled to the display mount interface 402 at an oblique angle with respect to the bezel edge 424 of the display device (e.g., and an oblique angle with respect to the display mount interface 402 and the upper frame 442). FIG. 5 includes a lower frame 444 which may be aligned parallel with the shelf 406. The shelf 406 may extend from the lower frame 444 and/or the beam 404 towards the space where the speaker 412 is to reside. The display mount interface 402 includes an alignment feature 440 corresponding to a feature 450 on the display bezel edge.

The speaker support apparatus 400 includes an inner beam 404 and an outer beam 446. The inner beam 404 of FIG. 5 is oblique (e.g., not orthogonal) with respect to the shelf 406 and the display mount interface 402. The inner beam 404 of FIG. 5 is smaller than the width the speaker 412 and may be substantially the same size or smaller than the width of the bezel 424. The width of the shelf 406 may be wider than the width of the beam 404 and thinner than the width of the plate 466. The outer beam 446 may be substantially perpendicular to the display mount interface 402. The outer beam 446 and/or the inner beam 404 may couple the upper frame 442 and the lower frame 444, and, in this manner, couple the shelf 406 to the display mount interface 402.

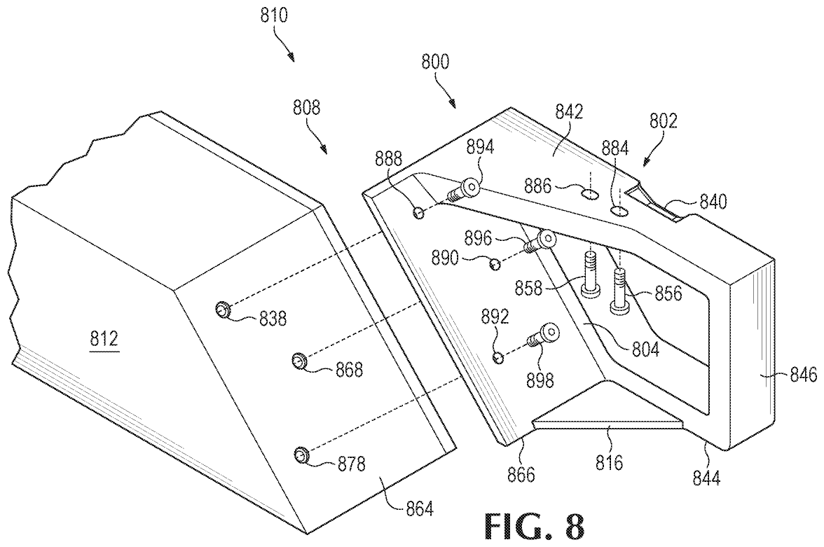

The speaker support apparatus 400 of FIG. 5 includes a plate 466 extending from the beam 404. The plate 466 may be substantially the same size as (or otherwise complementary to) a side of the speaker 412 and may align substantially flush with the side of the speaker 412. In some examples, the plate 466 may include an aperture to fasten the speaker 412 to the speaker support apparatus 400. Further description of an example speaker mount interface on a plate extending from a speaker support apparatus is discussed further with respect to FIG. 8. FIG. 6 is an exploded view of components of FIG, 5. The bottom face 460 of the speaker 412 includes an indent 462 corresponding to the shape of the shelf 406 (e.g., corresponding to a detent of the shelf 406). Indeed, the shelf 406 may include a cantilever with a contour forming a detent to couple to the speaker at the indented interface 462 of the bottom plate 460. The ident 462 of the bottom face 460 may align the speaker centered or otherwise properly oriented on the shelf 406. In this manner, the left shelf and the right shelf may be smaller than the width of the speaker 412, as shown in FIGS. 5 and 6. In other examples, the size of the shelf may be a different relative size, such as larger than the width of the speaker 412.

The width of the speaker 412 and the width of the display system 420 may be different size, such as shown in examples of FIGS. 4-6. The shelf 406, the beam 404, and the beam 446 may have different widths. For example, the width of the beam 446 may be substantially equal to the width of the display, the width of the beam 404 may be substantially equal to the width of the speaker, and the width of the shelf 406 may be less than the width of the speaker and larger than the width of the display. The width of the display mount interface 402 may be substantially equal to the width of the bezel 424 and the support mount interface 448.

Screw holes 470, 472, 474, and 476 in the shelf 406 and the surface 460 may align, through which fasteners 452 and 454 may secure the speaker 412 to the shelf 406. For example, the face 460 of the speaker may couple to the left shelf 406 and the right shelf via fasteners (e.g., 452 and 454) that fit into a channel formed by aligning screw holes of the speaker 412 and the screw holes of the left and right shelves. The speaker 412 may be fastened to the shelf 406 such that the oblique face 464 of the speaker 412 aligns substantially flush with the nonparallel beam 404 and nonparallel plate 466.

Screw holes 480, 482, 484, and 486 in the display mount interface 402 and the support mount interface 448 may align, through which fasteners 456 and 458 may secure the speaker support apparatus 400 to the display system 420 via the bezel 424.

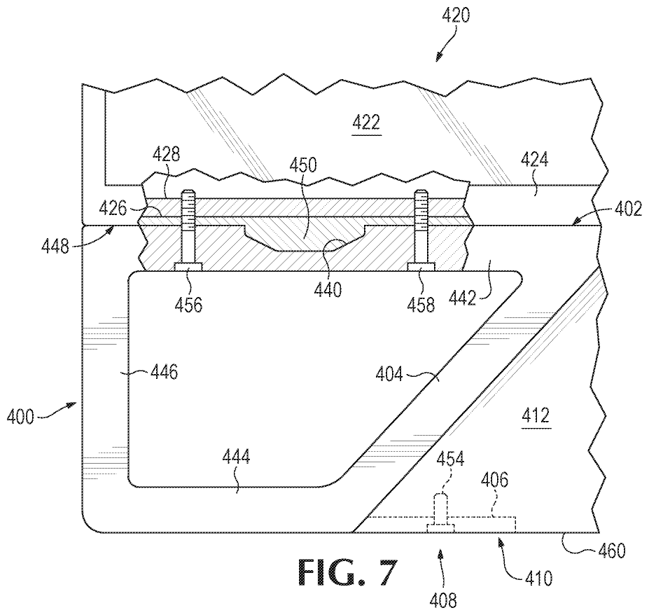

FIG. 7 is a front view of the example display system 420 with example internal structure shown. The speaker 412 of the audio system 410 is coupled to the speaker support apparatus 400 via an interface including a combination of the shelf 406 of the speaker support apparatus 400, a fastener 454, and the plate 460 of the speaker 412, In other examples, the speaker 412 may directly fasten to the beam 404, such as by using fasteners, rather than fasten to the shelf 406 (e.g., using fastener 454). The speaker 412 may align on the shelf 406 such that the speaker 412 lies flush with the beam 404, which may be nonparallel with respect to the shelf 406 and/or the display mount interface 402.

The cross section of the display as shown in FIG. 7 includes a bezel edge layer 426 and an internal support structure layer 428. The bezel 424 may cover the internal support structure layer 428 and part of the display panel 422. The display mount interface 402 of the speaker support apparatus 400 may include an internal support structure.

The display mount interface 402 of the speaker support apparatus 400 is abutted against the support mount interface 448 of the display system 420 and oriented into a proper location using the alignment feature 440 of the display mount interface 402 with the alignment feature 450 of the display system 420.

The fasteners 456 and 458 secure the display mount interface 402 to the support mount interface 448 via the bezel edge layer 426 and the internal support structure layer 428. Thus, the supportive internal structure of the display system 420 may be accessed using the interface to the speaker support apparatus 400 and, in turn, the speaker support apparatus 400 may be used to support a speaker 412. In this manner, the speaker 412 may be mounted to the display system 420 via the bezel 424 of the display system 420 using the speaker support apparatus 400.

FIG. 8 is an exploded view of an example audio system 810 including an example speaker support apparatus 800, The speaker support apparatus 800 includes a speaker mount interface 808. The speaker mount interface 808 is located on a plate 866 that extends from the beam 804 and generally including screw holes and fasteners (e.g., screw holes 838, 868, and 878 on the side 864 of the speaker housing, screw holes 888, 890, and 892 through the plate 866, and fasteners 894, 896, and 898). The speaker mount interface 808 allows the plate 866 (and/or the beam from which the plate extends) to directly fasten to the housing of the speaker 412. The plate 866 is orientated and shaped to complement the side 864 of the housing of the speaker 812 to which the plate 866 is to directly fasten.

The speaker support apparatus 800 generally includes an upper frame 842, a lower frame 844, side beam 846, side beam 804, a plate 866, and a shelf 816. The frames, beams, plate, and shelf may be separable components or may be manufactured as a unibody piece of supportive material. The upper frame 842 includes an alignment feature 840 and apertures 884 and 886 as part of a display mount interface 802 to assist coupling of the speaker support apparatus 800 to a display device. In some examples, the shelf 816 may extend past the plate 866 to provide a support for the bottom face of the speaker 812. As shown and discussed herein, there are many potential arrangements of the display mount interfaces and speaker mount interfaces to allow an audio system to be coupled to a display system via the display's bezel using a speaker support apparatus. Any such arrangements may be used individually or in combination to secure the speaker to the display via the display bezel using the speaker support apparatus.

All the features disclosed in this specification (including any accompanying claims, abstract and drawings), and/or all the elements of any method or process so disclosed, may be combined in any combination, except combinations where at least some of such features and/or elements are mutually exclusive.

The terms “include,” “have,” and variations thereof, as used herein, mean the same as the term “comprise” or appropriate variation thereof. Furthermore, the term “based on,” as used herein, means “based at least in part on.” Thus, a feature described as based on some stimulus may be based only on the stimulus or a combination of stimuli including the stimulus. The article “a” as used herein does not limit the element to a single element and may represent multiples of that element. Furthermore, use of the words “first,” “second,” or related terms in the claims are not used to limit the claim elements to an order or location, but are merely used to distinguish separate claim elements.

The present description has been shown and described with reference to the foregoing examples. It is understood that other forms, details, and examples may be made without departing from the spirit and scope of the following claims.

What is claimed is:

1. A speaker support apparatus comprising:
a display mount interface to couple to a bezel edge of a display;
a beam coupled to the display mount interface, the beam being nonparallel with respect to the bezel edge; and
a shelf coupled to the display mount interface via the beam.

2. The speaker support apparatus of claim 1, wherein:
the bezel edge is at the bottom of the display,
the display mount interface directly couples to the bottom bezel edge of the display; and
the shelf is coupled to the support beam by a fastener.

3. The speaker support apparatus of claim 2, further comprising:
an upper face to mount flush with the display bezel edge; and
a lower frame parallel to the upper frame and coupled to the upper frame by a perpendicular support, wherein
the beam couples the upper face to the lower frame, and
the shelf is mounted to the beam.

4. The speaker support apparatus of claim 1, wherein:
the beam is oblique with respect to the shelf.

5. The speaker support apparatus of claim 1, wherein:
the shelf includes a cantilever with a contour defining a detent to couple to a speaker mount interface using a fastener.

6. The speaker support apparatus of claim 1, wherein:
the display mount interface includes an alignment feature corresponding to a feature on the bezel edge of the display.

7. An audio system comprising:
a speaker having a housing;
a display mount interface to directly couple to a bezel edge of a display;
a beam coupled to the display mount interface at an oblique angle with respect to the bezel edge of the display; and
a speaker mount interface to directly fasten the beam to the housing of the speaker.

8. The audio system of claim 7, wherein:
the beam is smaller than a width of the speaker;
the speaker mount interface is located on a plate that extends from the beam;
the plate orientated and shaped to complement a side of the speaker to which
the plate is to directly fasten, the plate having a width wider than the width of the beam; and
the display mount interface includes a surface parallel to a shelf extending from the beam, a width of the shelf being wider than the width of the beam and thinner than the width of the plate.

9. The audio system of claim 7, wherein:
the bottom face of the speaker includes an indent corresponding to a detent of a shelf extending from the beam to align the speaker centered on the shelf.

10. A display system comprising:
a screen;
a bezel coupled to an edge of the screen, the bezel to house a support mount interface;
a left display mount interface to couple to a bezel edge on a first portion of a display, the left display mount interface including a structure parallel to the bezel edge and fastenable to the bezel edge such that the display mount interface is supported by the display system via the bezel edge;
a right display mount interface to couple to the bezel edge on a second portion of the display, the right display mount interface including a structure parallel to the bezel edge and fastenable to the bezel edge such that the display mount interface is supported by the display system via the bezel edge;
a left shelf coupled to the left display mount interface via a first beam; and
a right shelf coupled to the right display mount interface via a second beam.

11. The display system of claim 10, comprising:
a speaker coupleable to the left shelf and the right shelf, wherein the left shelf extends from the first beam at about a same plane as the right shelf extends from the second beam.

12. The display system of claim 11, wherein:
the left shelf and the right shelf are smaller than the width of the speaker;
the first beam includes a front surface located flush with the front face of the display; and
the speaker includes a bottom surface to which the left shelf and the right shelf are coupled.

13. The display system of claim 10, wherein:
the speaker includes a face defining a left indent and a right indent, the left indent complementary to a shape of the left shelf and the right indent complementary to a shape of the right shelf; and
the face of the speaker couples to the left shelf and the right shelf via fasteners that fit into a channel formed by aligning screw holes of the speaker and the left and right shelves.

14. The display system of claim 13, comprising:
the left display mount interface and the right display mount interface includes a face complementary to a shape of the bezel edge, the bezel edge located at a bottom of the display and the first beam and the second beam being nonparallel with respect to the bottom bezel edge of the display.

15. The display system of claim 10, wherein the support mount interface includes a support structure that extends to the display mount interface internal to the display housing.
